(19) United States
(12) Patent Application Publication
(10) Pub. No.: US 2026/0352927 A1
(43) Pub. Date: Nov. 5, 2026

(54) METHOD AND SYSTEM FOR AUTOMATED CAMERA SWITCHING FOR BROADCASTS

(71) Applicant: Musco Corporation, Oskaloosa, IA (US)

(72) Inventors: Russell M. Dobbins, Earlham, IA (US); Sin Yong Tan, West Des Moines, IA (US); Venkata Karthik Sai Madala, West Des Moines, IA (US); Andrew J. Schembs, Johnston, IA (US); Cobi J. Sabo, Denver, CO (US)

(21) Appl. No.: 19/665,747

(22) Filed: May 1, 2026

Related U.S. Application Data
(60) Provisional application No. 63/798,284, filed on May 1, 2025.

(51) Int. Cl. H04N 21/6587; G06T 7/70; G06V 40/10; G06V 40/20; H04N 21/218; H04N 21/234

(52) U.S. Cl. CPC H04N 21/6587; G06T 7/70; G06V 40/103; G06V 40/23; H04N 21/21805; H04N 21/23418

(57) ABSTRACT

An automated camera switching method for broadcast systems is disclosed. The method includes broadcasting a first camera view from a plurality of camera views and monitoring video streams from the plurality of camera views to detect a catalyst event. Upon detecting the catalyst event, the method determines whether to switch to a second camera view and, if so, switches the broadcast from the first camera view to the second camera view. The second camera view is then broadcast to viewers. The method enables dynamic and contextually relevant transitions between camera views, enhancing the broadcast experience by automating the selection of optimal perspectives based on real-time event detection.

### RELATED APPLICATIONS

This application claims the benefit of U.S. Provisional Application No. 63/798,284, filed May 1, 2025, the entire contents of which are incorporated herein.

### TECHNICAL FIELD

The disclosure relates to automated video broadcasting systems, particularly focusing on camera switching technologies.

### BACKGROUND OF THE INVENTION

In modern sports broadcasting, the challenge of seamlessly switching between multiple camera views has become increasingly significant. The field encompasses a wide range of imaging systems that capture dynamic scenes during live events. Broadcasters employ various camera angles to provide viewers with comprehensive visual coverage of the action. This sector integrates advanced video processing techniques and intelligent control mechanisms to ensure that the selected visual perspective aligns with the unfolding event.

A primary goal in this domain is to deliver a broadcast that captures significant moments as they occur, ensuring that viewers are presented with informative and engaging visual content. Effective camera switching aims to identify important events and subtle scene changes, allowing the system to adjust the displayed view in real time. This approach enhances the clarity of the narrative by maintaining continuity during moments of rapid action.

Existing solutions for managing multiple imaging sources often encounter challenges that impede optimal viewing experiences during fast-paced live events. Systems can struggle to adjust quickly to rapidly changing scenes, and the timing of transitions may not consistently align with significant moments in play. In many cases, the techniques used to manage these transitions are hindered by limitations in their ability to effectively interpret shifts in scene dynamics, leading to slight delays or abrupt changes in the displayed content.

A more specific challenge arises from the difficulty in synchronizing analytical insights with the instantaneous nature of live broadcasting. Minor discrepancies in detecting important scene elements can result in delayed or mistimed view changes, causing viewers to miss portions of significant actions. The issue is further compounded when systems are required to differentiate between subtle movements and notable events, often leading to occasional inconsistencies in camera selection.

### SUMMARY OF THE INVENTION

In general, the disclosure describes a process for automatically switching camera views during a broadcast, such as a broadcast of a baseball or softball game. By default, a broadcast may begin showing a video stream from a camera located on a backstop and directed towards the outfield. After the players take the field, a pitcher may begin a pitching motion. A computing device may analyze the video stream to detect when this pitching motion begins in the video stream and automatically switch the feed to show a video stream from a camera located in the outfield and directed towards the backstop, as this angle may be more optimal for showing pitching and batting motions. Upon some non-pitching and non-hitting action, such as running to first base after a hit, a pickoff attempt, a stolen base attempt, etc., the computing device may detect such an event and switch the feed back to the backstop camera directed towards the outfield, as the backstop camera may be better situated to show action in the field that does not involve pitching and hitting. This toggling may continue throughout the duration of the broadcast, thereby providing the viewer with the optimal viewing angle and camera feed for each situation in the game.

In one example, the disclosure includes a method for automated camera switching in a broadcast system. The method comprises broadcasting a first video stream from a selected camera view while concurrently monitoring one or more video streams from a plurality of camera views to detect a catalyst event. The catalyst event may be detected by determining that an identified subject, such as a pitcher within a predefined region of interest, transitions from a stationary state to a moving state based on a predetermined displacement threshold, by analyzing a coordinate history indicative of motion toward home plate, by recognizing an increase in an aspect ratio of a bounding box that exceeds a predetermined threshold, and/or by identifying a pitching motion while a batter is simultaneously present in the first view.

In some examples, the method further includes storing video frames from each camera view in a first-in-first-out buffer and performing analysis on a frame that is a defined temporal distance from a corresponding display frame to enable anticipatory switching. In these embodiments, the broadcast is switched at a particular frame timestamp that precedes the timestamp of the analysis frame. The method also encompasses analyzing the video streams using a person detection model that identifies and localizes individuals, correlating the identified persons with predefined regions of interest for subjects such as a pitcher and a batter. Additionally, the catalyst event may be detected by monitoring the rapid and substantial movement of one or more players, which involves calculating the Euclidean distance traveled by each player over a predetermined time interval, performing a top-down perspective transform on bounding boxes to compute positions on a common field coordinate system, and excluding from analysis any players positioned beyond a predetermined radius from a reference point such as home plate.

Furthermore, the method may include automatically reverting the broadcast back to the original camera view after a predetermined duration, or detecting the catalyst event based on the passing of a predetermined duration. In certain configurations, the initial view comprises a view of a backstop from a camera located in an outfield while the subsequent view comprises a view of the outfield from a camera positioned on the backstop, or vice versa. In other examples, monitoring the video streams may involve analyzing either the first or the second video stream to detect the catalyst event while the first video stream remains the one being broadcast.

In one example, the disclosure is directed to a method that includes broadcasting, by one or more processors, a first video stream from a first camera view from a plurality of camera views. The method further includes monitoring one or more video streams from the plurality of camera views to detect a catalyst event. The method also includes determining, by the one or more processors, and based on the detected catalyst event, to switch the broadcast from the first camera view to a second camera view of the plurality of camera views. The method further includes, in response to determining to switch the broadcast, switching, by the one or more processors, to broadcasting a second video stream from the second camera view instead of the first video stream from the first camera view.

In another example, the disclosure is directed to a method for performing any combination of techniques described herein.

In another example, the disclosure is directed to a device configured to perform any combination of techniques described herein.

In another example, the disclosure is directed to an apparatus comprising means for performing any combination of techniques described herein.

In another example, the disclosure is directed to a non-transitory computer-readable storage medium containing instructions. The instructions, when executed, cause one or more processors to perform any combination of techniques described herein.

In another example, the disclosure is directed to a system comprising one or more computing devices configured to perform any combination of techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating a streaming system configured to automatically switch between feeds from multiple cameras, in accordance with one or more techniques described herein.

FIG. 2 is a block diagram illustrating a more detailed example of a computing device configured to perform the techniques described herein.

FIG. 3 is a diagram illustrating example camera views from a backstop and an outfield, in accordance with one or more techniques described herein.

FIG. 4 is a diagram illustrating an example batter and pitcher region of interest and a pitcher's historical position, in accordance with one or more techniques described herein.

FIG. 5 is a diagram illustrating example aspect ratios of a pitcher during a pitching motion, in accordance with one or more techniques described herein.

FIG. 6 is a diagram illustrating an example of a batter being occluded by an umpire, in accordance with one or more techniques described herein.

FIG. 7 is a flow diagram illustrating an example motion-based process for switching camera feeds, in accordance with one or more techniques described herein.

FIG. 8 is a diagram illustrating images before and after a perspective transform, in accordance with one or more techniques described herein.

FIG. 9 is a conceptual diagram illustrating an example analysis and broadcast operating timeline, in accordance with one or more techniques described herein.

FIG. 10 is a flow diagram illustrating an example process for automatically switching camera feeds, in accordance with one or more techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

This disclosure pertains to automated camera switching systems for broadcast applications, particularly in sports environments such as baseball and softball. The described system leverages artificial intelligence (AI) and heuristic-based techniques to dynamically select and switch between multiple camera views, enhancing the viewer experience by broadcasting the most relevant perspective based on detected events, such as pitching motions or player movements.

The examples and embodiments described herein are provided for illustrative purposes only and are not intended to limit the scope of the described subject matter. Certain widely recognized elements, processes, or techniques may be omitted or described in less detail to avoid obscuring the described subject matter, as they are readily understood by those skilled in the art. Furthermore, various modifications, rearrangements, or substitutions of components and steps may be made without departing from the spirit and scope of the described subject matter, as defined by the claims.

An automated camera switching system for a sports broadcast can selectively switch between multiple camera views based on real-time analysis of gameplay. A computing device may receive video streams from a backstop camera and an outfield camera and broadcast a selected one of the video streams while concurrently monitoring one or more of the video streams to detect a catalyst event indicating that another camera view is better suited for the current phase of play. For example, the computing device may switch from a backstop view to an outfield view upon detecting a pitching sequence and may switch from the outfield view back to the backstop view upon detecting non-pitching gameplay such as base running, a stolen-base attempt, or a pickoff play.

The computing device may detect the catalyst event using artificial intelligence and heuristic-based analysis. A person detection model may identify players in video frames, and predefined regions of interest may be used to identify a pitcher and a batter. A pitching sequence may be detected based on one or more conditions including a pitcher transitioning from stationary to moving, pitcher movement toward home plate, an increase in an aspect ratio of a pitcher bounding box indicating a pitching motion, and optionally batter presence. A non-pitching gameplay event may be detected based on rapid and substantial movement of one or more players, which may include perspective-transforming detected player positions into a common field coordinate system, excluding distant players beyond a threshold radius from home plate, tracking players across frames, and calculating distance traveled over a time interval.

The computing device may store frames from multiple camera views in a first-in, first-out buffer and perform analysis on frames that are temporally ahead of frames being broadcast. As a result, a switching decision may be associated with an earlier timestamp so that the broadcast transitions at or before the start of a detected event rather than after the event is already underway. By combining event-driven switching logic, multi-camera monitoring, and anticipatory switching based on buffered video, the disclosed system may improve the timeliness and relevance of broadcast camera selection in baseball or softball environments while reducing reliance on manual camera switching.

Live event broadcasts that rely on multiple camera views can be difficult to present in a way that consistently captures the most relevant action at the right moment. In fast-moving game situations, transitions between views may occur too late, too early, or in response to incomplete scene interpretation, which can cause important portions of a play to be partially missed or shown from a less informative perspective. Additional difficulty arises because motion cues and player activity can vary substantially across different field locations and camera angles, such that a switching decision based only on a current displayed frame or a rigid trigger may not reliably distinguish a pitching sequence from broader field activity.

To address these issues, the present disclosure describes a computing-based switching architecture that monitors multiple video streams and detects catalyst events from player behavior and scene context, while a selected stream is being broadcast. In some implementations, detected persons may be correlated with predefined field regions so that movement associated with a pitcher, batter, or other players can be evaluated using displacement history, motion direction, bounding-box shape changes, player-presence conditions, and combinations thereof to identify a likely pitch sequence or another gameplay transition. The switching logic may also analyze buffered frames that are temporally ahead of a displayed frame, thereby enabling an anticipatory switch at an earlier timestamp so that a viewer is presented with a more complete event sequence. For broader field action, the architecture may detect rapid player movement using a normalized field-coordinate representation derived from perspective transformation and distance-based filtering, and may return to a wider view based on detected movement and/or elapsed time. In this manner, the disclosed techniques can improve switching timing, reduce missed action, and provide more contextually relevant view selection without requiring manual camera control.

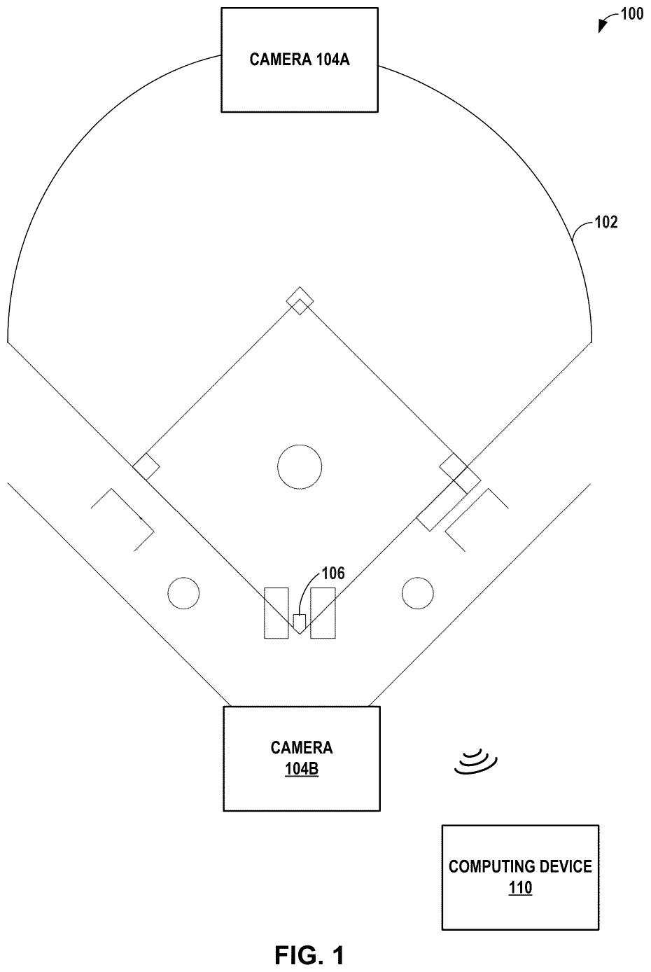

FIG. 1 is a conceptual diagram illustrating streaming system 100 that includes sports field 102 with cameras 104A-104B (collectively, cameras 104) installed on location with a computing device for switching between feeds of the cameras during a broadcast, in accordance with one or more techniques described herein. While the example of FIG. 1 illustrates video system 100 with two instances of cameras 104, other instances of video system 100 may include more cameras or fewer cameras.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Cameras 104 may be any camera capable of recording a video stream and transmitting that video stream to computing device 110, either wirelessly or through a wired connection.

In accordance with the techniques of this disclosure, computing device 110 may broadcast a first video stream from a first camera view from a plurality of camera views, such as a view captured by camera 104B. Computing device 110 may monitor one or more video streams from the plurality of camera views to detect a catalyst event. Computing device 110 may determine, based on the detected catalyst event, to switch the broadcast from the first camera view to a second camera view of the plurality of camera views. In response to determining to switch the broadcast, computing device 110 may switch to broadcasting a second video stream from the second camera view (e.g., the view from camera 104A) instead of the first video stream from the first camera view.

The disclosed techniques provide a particular technological improvement in automated video broadcasting systems by improving how a computing system selects and transitions between camera views during a live sports broadcast. Rather than merely choosing among views based on an abstract preference, the computing system processes multiple live video streams using a person detection model, predefined regions of interest, coordinate histories, displacement thresholds, aspect-ratio analysis, perspective transformation, and movement-based decision logic to detect catalyst events associated with gameplay. These operations are tied to particular video frames, player locations, field geometry, and switching states of a multi-camera broadcast architecture, and in this way improve operation of the broadcast system itself.

The disclosed techniques also improve timing and accuracy of camera switching through a first-in, first-out buffer that stores video frames and enables analysis of frames that are temporally ahead of frames currently being broadcast. By pairing a switching decision with an earlier timestamp, the computing system can switch views in a manner that captures the beginning of a pitch, base-running play, pickoff attempt, or other gameplay event, thereby reducing delayed transitions and missed action. Further, use of a top-down perspective transform and distance-based filtering improves reliability of movement analysis by normalizing player positions across the field and reducing false switching caused by distant detections. Accordingly, the disclosed techniques are directed to a concrete improvement in computer-implemented broadcast control and video processing, and may be implemented using particular computing components and camera configurations to achieve contextually accurate and technically efficient live camera switching.

In the domain of sports broadcasting, particularly for baseball and softball games, the challenge of providing an optimal viewing experience is compounded by the need to dynamically switch between different camera views. Conventional approaches often rely on manual camera switching, which is prone to human error, delays, and inconsistencies. These methods fail to account for the rapid pace of gameplay and the nuanced transitions between significant moments, such as pitching, batting, base running, and fielding. As a result, viewers may miss important events or experience less-than-ideal perspectives, detracting from the overall broadcast quality. Additionally, existing automated systems, if any, lack the sophistication to accurately predict or respond to game events in real-time, often relying on rigid heuristics that fail to adapt to the variability of live sports.

The inventive concept addresses these limitations by introducing an automated camera switching system that leverages artificial intelligence (AI) and advanced heuristics to dynamically select the optimal camera view based on real-time analysis of gameplay. The system incorporates specialized algorithms and machine learning models, such as a pre-trained YOLOv5 person detection model, to identify and localize players within video frames. By defining regions of interest (ROIs) for prominent players, such as the pitcher and batter, the system can accurately track their movements and behaviors. This enables the detection of catalyst events, such as a pitcher transitioning from stationary to moving, stepping towards home plate, or performing a pitching motion, which serve as triggers for switching the broadcast from one camera view to another.

The solution further enhances accuracy and responsiveness through the use of a first-in-first-out (FIFO) buffer, allowing the system to analyze frames ahead of the broadcasted view. This “look-ahead” feature ensures anticipatory switching, enabling viewers to experience the entirety of significant events, such as a pitch, from start to finish. Additionally, the system employs techniques like perspective transformation to normalize player movements across different camera angles, ensuring consistent and reliable detection of rapid and substantial movements. For scenarios requiring broader gameplay coverage, such as base running or pickoffs, the system incorporates motion-based and/or duration-based switching logic to revert to the backstop view.

By combining AI-driven analysis, heuristic-based decision-making, and architectural optimizations, the inventive concept significantly improves upon prior approaches. This approach removes the need for manual intervention, reduces the risk of missed events, and delivers a seamless and engaging viewing experience tailored to the dynamic nature of baseball and softball gameplay.

The techniques of this disclosure include a method for automated camera switching in a broadcast system, which involves broadcasting a video stream from a first camera view, monitoring video streams to detect a catalyst event, determining whether to switch to a second camera view based on the detected event, and broadcasting the second video stream upon switching.

This arrangement enables dynamic adaptation of the broadcast to the ongoing events in a sports game, ensuring that the most relevant camera view is displayed to the audience. By automating the switching process, the method eliminates the need for manual intervention, which can be prone to delays or errors, particularly in fast-paced scenarios. The use of a catalyst event as the trigger for switching ensures that the broadcast transitions are contextually appropriate, aligning with the progression of the game and enhancing the viewer's experience.

The physical arrangement of the system, where multiple camera views are monitored simultaneously, allows for real-time analysis and decision-making. This ensures that the broadcast system can respond promptly to changes in the game environment, such as a pitch or a player movement, without requiring pre-programmed sequences or human oversight. The ability to detect and act upon specific events, such as a pitching motion or a player sprint, provides a level of granularity and precision that is not achievable with traditional camera switching methods.

Furthermore, the method provides a practical solution to the problem of maintaining viewer engagement during sports broadcasts. By dynamically switching between camera views based on game events, the system ensures that the audience is presented with an informative and visually engaging perspective at any given moment. This approach reduces the likelihood of missing significant moments in the game and enhances the overall quality of the broadcast.

System 100 integrates a specific technological improvement within the field of automated camera switching for sports broadcasting. The described system leverages a combination of artificial intelligence (AI) models, such as a pre-trained YOLOv5 person detection model, and heuristic-based decision-making to address the technical problem of accurately and efficiently switching between backstop and outfield camera views during a live broadcast. By incorporating a look-ahead analysis feature, the system operates in a manner that anticipates future events, enabling precise timing for camera transitions and enhancing the viewer's experience. This approach represents a concrete application of AI and heuristics to solve a real-world problem in a manner that is neither abstract nor generic, as it involves specific configurations, such as region-of-interest (ROI) definitions, perspective transformations, and motion-based detection pipelines, to achieve the desired functionality. As a result, the described system provides a practical and technological solution that is firmly rooted in the domain of sports broadcasting.

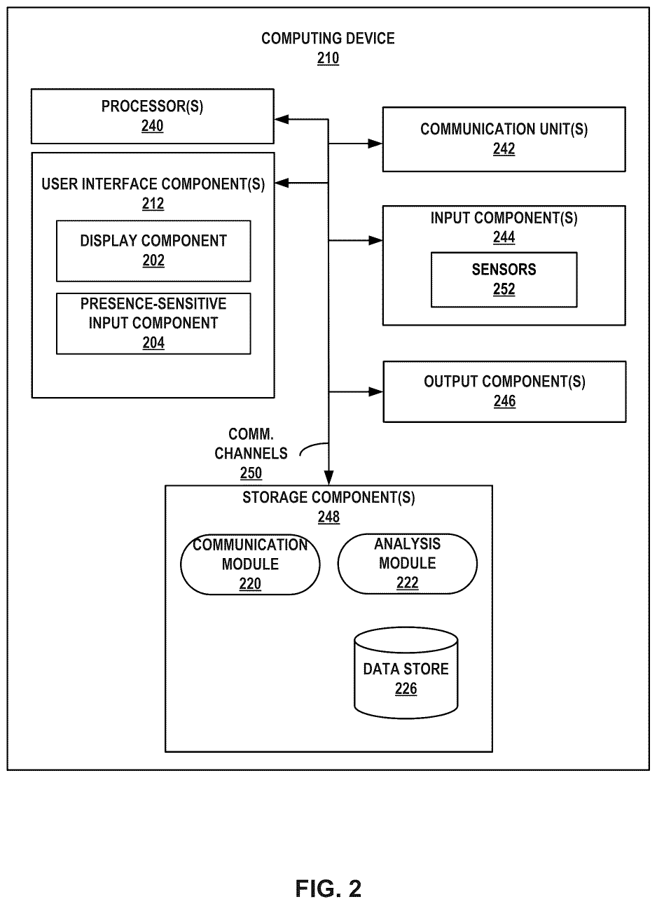

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to automatically switch between cameras during a broadcast after a catalyst event. That is, processors 240 may implement functionality and/or execute instructions associated with computing device 210 to detect a catalyst event in a video stream and change feeds to a different camera view upon detecting the catalyst event.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to detect a catalyst event in a video stream and change feeds to a different camera view upon detecting the catalyst event.

Communication module 220 may execute locally (e.g., at processors 240) to provide functions associated with receiving video streams from cameras and broadcasting the video streams over some communication medium (e.g., internet, cable, etc.). In some examples, communication module 220 may act as an interface to a remote service accessible to computing device 210. For example, communication module 220 may be an interface or application programming interface (API) to a remote server that receives video streams from cameras and broadcasts the video streams over some communication medium (e.g., internet, cable, etc.).

In some examples, analysis module 222 may execute locally (e.g., at processors 240) to provide functions associated with monitoring the video streams to detect catalyst events. In some examples, analysis module 222 may act as an interface to a remote service accessible to computing device 210. For example, analysis module 222 may be an interface or application programming interface (API) to a remote server that monitors the video streams to detect catalyst events.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may broadcast a first video stream from a first camera view from a plurality of camera views. In some instances, the first camera view may be a view of a backstop from a camera located in an outfield, and the second camera view may be a view of the outfield from a camera located on the backstop. Broadcasting a backstop view from an outfield camera and an outfield view from a backstop camera ensures that the system can dynamically adapt to different perspectives, providing viewers with optimal visual coverage.

Alternatively, the first camera view may be a view of an outfield from a camera located on a backstop, and the second camera view may be a view of the backstop from a camera located in the outfield. Configuring the first and second camera views to provide complementary perspectives ensures that the broadcast system can capture both pitching and gameplay action, enhancing the overall viewing experience.

Analysis module 222 may monitor one or more video streams from the plurality of camera views to detect a catalyst event. In some instances, in monitoring the one or more video streams, analysis module 222 may analyze the second video stream to detect the catalyst event in the second video stream while broadcasting the first video stream. Monitoring the second video stream while broadcasting the first video stream ensures that the system can detect catalyst events in the alternate view, enabling proactive switching to the optimal camera.

Alternatively or additionally, in monitoring the one or more video streams, analysis module 222 may analyze the first video stream to detect the catalyst event in the first video stream while broadcasting the first video stream. Monitoring the first video stream while broadcasting the first video stream ensures that the system can detect catalyst events in the current view, allowing for seamless transitions to alternate views when necessary.

In some instances, in detecting the catalyst event, analysis module 222 may detect a pitcher, identified within a predefined region of interest, transitioning from a stationary state to a moving state based on a predetermined displacement threshold. Detecting a pitcher transitioning from a stationary state to a moving state ensures precise identification of the start of a pitching motion, facilitating timely switching to the optimal camera view for capturing the pitching action.

Additionally or alternatively, in detecting the catalyst event, analysis module 222 may determine a coordinate history of a pitcher, identified within a predefined region of interest, is indicative of motion towards home plate. Detecting motion toward home plate provides an additional layer of accuracy in identifying pitching events, ensuring that the broadcast switches to the outfield view at the appropriate moment.

Additionally or alternatively, in detecting the catalyst event, analysis module 222 may determine that a pitcher is performing a pitching motion by detecting that an increase in an aspect ratio of a bounding box of the pitcher exceeds a predetermined threshold. Using the aspect ratio of the pitcher's bounding box to detect pitching motion enhances the reliability of the system by leveraging observable changes in the pitcher's posture, reducing false positives in camera switching.

Additionally or alternatively, in detecting the catalyst event, analysis module 222 may identify a pitching motion while a batter is simultaneously present in the first camera view. Incorporating batter presence as a condition for switching ensures that the broadcast captures the complete pitching and batting interaction, improving the contextual relevance of the selected camera view.

In some instances, communication module 220 may store video frames from each of the plurality of camera views in a first-in-first-out (FIFO) buffer, such as data store 226. In such instances, when detecting the catalyst event, analysis module 222 may perform analysis on an analyze frame that is a particular distance from a corresponding display frame in the broadcasted first camera view to facilitate anticipatory switching. Storing video frames in a FIFO buffer and analyzing frames ahead of the broadcast facilitates anticipatory switching, ensuring that the broadcast transitions occur seamlessly and align with the start of significant events. As such when switching the broadcast from the first camera view to the second camera view, communication module 220 may switch the broadcast at a particular frame timestamp that is prior to a timestamp of the analysis frame. Switching the broadcast at an earlier timestamp ensures that viewers see the complete sequence of an event, enhancing the continuity and accuracy of the broadcast.

In some instances, in monitoring the one or more video streams, analysis module 222 may analyze the video streams using a person detection model based to identify and localize persons within the video frames. Using a person detection model to identify and localize persons within video frames improves the system's ability to accurately detect players and events, enabling more precise camera switching. For example, the identified persons may be correlated with predefined regions of interest corresponding to a pitcher and a batter. Correlating identified persons with predefined regions of interest ensures that the system focuses on relevant players, such as the pitcher and batter, thereby improving the accuracy of event detection.

In some instances, in detecting the catalyst event, analysis module 222 may detect a rapid and substantial movement of one or more players by calculating a Euclidean distance traveled by each of the one or more players over a predetermined time interval. Detecting rapid and substantial movement of players ensures timely switching to the backstop view during high-action moments, such as base running or pickoffs, enhancing the broadcast's ability to capture critical gameplay.

In detecting the rapid and substantial movement, analysis module 222 may use a person detection model based to identify the one or more players and localize the one or more players using bounding boxes. Analysis module 222 may perform a top-down perspective transform on each of the bounding boxes to compute positions of the one or more players on a common field coordinate system. Analysis module 222 may exclude from analysis any detected persons whose computed positions are located at a Euclidean distance exceeding a predetermined radius from a reference point corresponding to home plate. analysis module 222 may detect the rapid and substantial movement of the one or more players by calculating the Euclidean distance traveled by each of the one or more players over the predetermined time interval

By performing a top-down perspective transform on bounding boxes of detected players, the system normalizes the spatial representation of player positions on the field, accounting for distortions caused by the camera's angled view. This ensures that movements of players closer to or farther from the camera are accurately scaled and represented in a common field coordinate system, enabling precise calculation of distances traveled.

Excluding players located beyond a predetermined radius from the home plate reduces noise in the analysis by filtering out distant players whose detection may be inconsistent due to their small size in the video frame. This step minimizes false positives in movement detection and improves the reliability of the switching decision pipeline.

The use of Euclidean distance calculations over a predetermined time interval to detect rapid and substantial player movements provides a robust mechanism for identifying significant gameplay events, such as a player sprinting towards a base. This ensures that the camera switching logic is responsive to dynamic gameplay scenarios, enhancing the broadcast's ability to capture important moments.

By integrating person detection, perspective transformation, and movement analysis, the system achieves a reliable and computationally efficient method for determining when to switch camera views, ensuring that the broadcast remains focused on the most relevant gameplay actions.

In some instances, in detecting the catalyst event, analysis module 222 may detect a passing of a predetermined duration. Detecting the passing of a predetermined duration as a catalyst event ensures that the broadcast transitions occur in a timely manner, even in the absence of specific player actions, maintaining the flow of the broadcast.

Analysis module 222 may determine, based on the detected catalyst event, to switch the broadcast from the first camera view to a second camera view of the plurality of camera views. In response to determining to switch the broadcast, communication module 220 may switch to broadcasting a second video stream from the second camera view instead of the first video stream from the first camera view.

In some instances, communication module 220 may automatically revert the broadcast from the second camera view back to the first camera view after a predetermined duration. Automatically reverting the broadcast to the initial camera view after a predetermined duration ensures that the system returns to the default view when no further catalyst events are detected, maintaining a consistent viewing experience.

In one example, the broadcast can currently be outputting an outfield view after a prior switch associated with a detected pitch sequence. While the outfield view remains selected for broadcast, a computing device can continue analyzing one or more outfield-view frames to determine whether a motion-based switching condition is satisfied. The computing device can detect one or more players in the outfield-view frames using a person detection model, can transform corresponding player positions into a common field coordinate system, can disregard players located beyond a threshold distance from home plate, can track remaining players across frames, and can calculate a distance traveled by a respective tracked player over a time interval. When the computing device determines that at least one tracked player has moved rapidly and substantially, such as when a batter begins running toward first base or a runner attempts to steal a base, the computing device can determine that a catalyst event has occurred and can switch the broadcast from the outfield view to a backstop view. In this way, the motion-based switching logic can govern a first switching direction in which the system transitions from the outfield view to the backstop view in response to developing field action.

After the broadcast has switched to the backstop view, the computing device can continue monitoring gameplay while the backstop view is being broadcast. In some examples, the computing device can determine that the motion-based gameplay sequence has ended when no additional rapid and substantial player movement is detected for a period of time. In some examples, the computing device can additionally or alternatively determine that a predetermined duration has elapsed since the switch to the backstop view. In response to determining that the movement-based gameplay sequence has ended and/or that the predetermined duration has elapsed, the computing device can revert the broadcast from the backstop view to the original outfield view. The reverted outfield view can thereafter remain selected until another catalyst event is detected. This example accordingly illustrates a full switching cycle in which a first switching direction is triggered by motion-based analysis and a second switching direction returns the broadcast to the original camera view after the motion-based event has concluded.

Different switching directions in a multi-camera broadcast workflow may be governed by different trigger logic depending on the type of gameplay to be captured. For example, a first switching direction from a backstop view to an outfield view may be triggered based on detection of a pitch-related catalyst event, while a second switching direction from the outfield view back to the backstop view may be triggered based on detection of broader field movement, expiration of a duration threshold, or both. Accordingly, the disclosed techniques may apply different analyses, conditions, and decision criteria to different switching directions while still operating within a common automated camera-switching architecture. The following examples illustrate representative full switching cycles in which the system transitions from an original view to another view based on a first type of catalyst event and subsequently returns to the original view based on a different type of catalyst event or timing condition.

In another example, the broadcast can initially be outputting a backstop view while a computing device monitors one or more backstop-view frames for a pitch-related catalyst event. The computing device can detect persons in the backstop-view frames using a person detection model and can identify a pitcher and a batter using one or more predefined regions of interest associated with the field. The computing device can evaluate one or more pitch-related conditions, such as whether the pitcher transitions from stationary to moving, whether the pitcher moves toward home plate, whether an aspect ratio of a pitcher bounding box exceeds a threshold indicating a pitching motion, and whether a batter is present. When the computing device determines that the pitch-related catalyst event has occurred, the computing device can switch the broadcast from the backstop view to an outfield view so that a pitch, ball trajectory, and batting action can be shown from a perspective better suited for that phase of play. In this way, the pitch-detection logic can govern a first switching direction in which the system transitions from the backstop view to the outfield view in response to a detected pitching sequence.

After the broadcast has switched to the outfield view, the computing device can continue monitoring gameplay while the outfield view is being broadcast. In some examples, the computing device can analyze outfield-view frames to detect a motion-based catalyst event corresponding to broader field action. For example, the computing device can detect one or more players in the outfield-view frames, transform corresponding player positions into a common field coordinate system, remove players located beyond a threshold distance from home plate, track remaining players across frames, and determine whether at least one tracked player has moved rapidly and substantially over a time interval. When the computing device determines that such movement has occurred, such as when a batter runs toward first base, a runner attempts to steal a base, or a pickoff play develops, the computing device can switch the broadcast from the outfield view back to the original backstop view. In some examples, the computing device can additionally or alternatively switch from the outfield view back to the backstop view after a predetermined duration has elapsed. This example accordingly illustrates a full switching cycle in which a first switching direction is triggered by pitch detection and a second switching direction returns the broadcast to the original camera view based on motion-based analysis and/or elapsed duration.

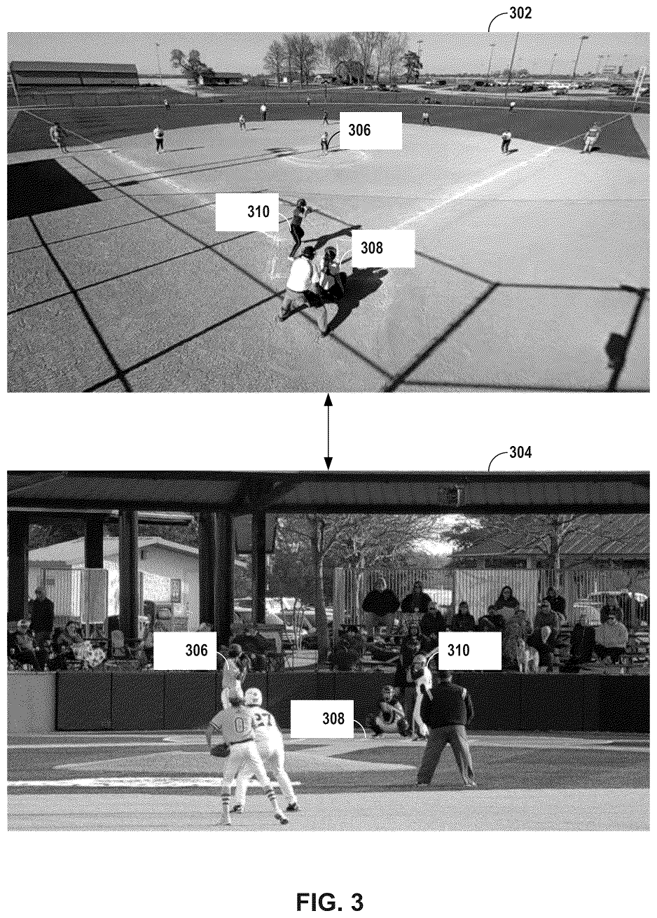

FIG. 3 is a diagram illustrating example camera views from a backstop-view camera image 302 and an outfield-view camera image 304, in accordance with one or more techniques described herein. In certain online streaming broadcasts, two different views may be used, including the backstop-view camera image 302 and the outfield-view camera image 304 shown in FIG. 3, where each may be installed for a different purpose. The outfield-view camera image 304 may provide a viewing experience during pitches in which viewers can see a pitcher 306, a trajectory of a pitched ball, a batter 310, and a home plate 308. The backstop-view camera image 302 may be better suited for gameplay sequences including baserunning, stolen-base attempts, and pickoff plays. A switching pipeline may automate a camera-switching broadcast process by combining artificial intelligence and heuristics.

Initially, the video stream will receive video streams from both the backstop and outfield view cameras, and these frames may be stored in a small first-in-first-out(FIFO) buffer, awaiting a decision on which view should be broadcasted to the viewer. During analysis, the latest backstop view is used as the analyze frame. A computing device using the camera switching logics to determine the timing to perform the switching and the switching decisions may be stored in a queue. During the start of a broadcast, a pair of timestamped backstop and outfield frame are retrieved from the FIFO buffer, and combining with the decision from the decision queue, the system broadcasts the selected view to the viewers. This process is then repeated again.

In some instances, the analyze frame is L frames ahead of the display frame (or the frame currently being broadcasted, which allows the analysis to look ahead to the future and stay L frames ahead of the broadcast. This allows the system to better broadcast the start of different stages of the game more accurately to the viewers.

Upon system initialization, the broadcast may be defaulted to the backstop view, thus the computing device will initialize the switching logic to determine the timing to switch the broadcast from the backstop camera to the outfield camera. In general, the backstop-to-outfield switching logic consists of any number of triggering conditions and can include any one or more of: 1. Pitcher is stationary and transitioned into moving 2. Pitcher is moving towards home plate 3. Pitcher is in the middle of a pitching motion 4. Batter presence (situational). In some instances, all conditions need to be fulfilled in order to trigger the backstop-to-outfield camera switch, but other instances may only require a subset of these conditions.

One of the components in the camera switching pipeline is person detection, where the computing device localizes the location of person visible in the frame using bounding boxes. The computing device may use any capable person detection model, including a pre-trained YOLOv5 model.

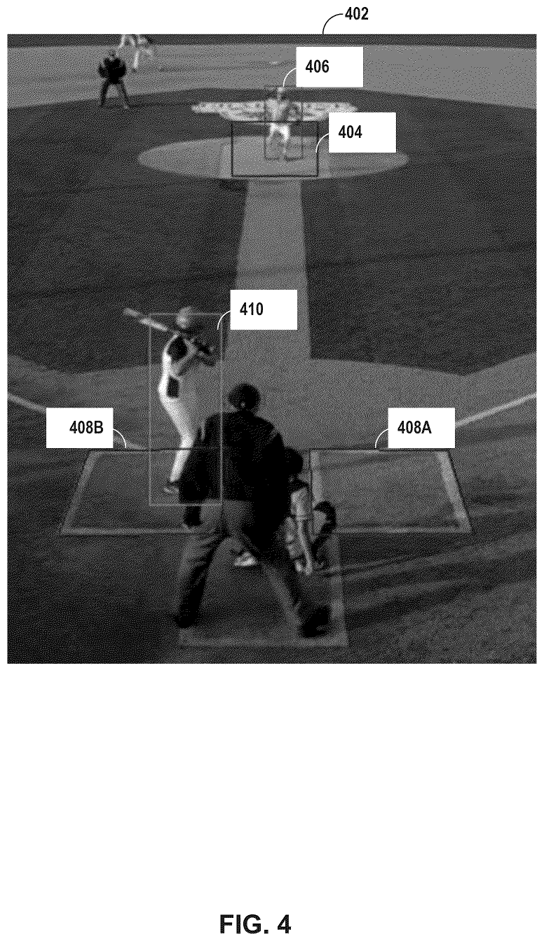

FIG. 4 is a diagram illustrating an example image 402 including a batter region of interest 408A, a batter region of interest 408B, a pitcher region of interest 404, a detected pitcher 406, and a detected batter 410, in accordance with one or more techniques described herein. A computing device may identify a pitcher and a batter within a backstop camera view. In some embodiments, regions of interest may be predefined during a configuration stage for a particular field. As shown in FIG. 4, the pitcher region of interest 404 and the batter regions of interest 408A and 408B may define candidate locations for detecting player activity. The detected pitcher 406 and the detected batter 410 may correspond to player detections within the image 402. The computing device may use these regions of interest and detections as part of logic for identifying gameplay events and for determining whether to switch between camera views.

FIG. 4 illustrates an example image 402 in which a pitcher region of interest 404 and batter regions of interest 408A, 408B are defined for use in identifying a pitcher and a batter within the image 402. In the example of FIG. 4, a detected pitcher 406 is shown within the pitcher region of interest 404, and a detected batter 410 is shown within one of the batter regions of interest 408A, 408B. In some embodiments, the batter and pitcher regions of interest are depicted by blue polygons, the detected batter 410 is depicted by a green box, and the detected pitcher 406 is depicted by a red box. In some examples, another green line near the feet of the detected pitcher 406 depicts a trail of the recent historical positions of the detected pitcher 406 over a preceding time period.

Using person-detection results represented as bounding boxes together with the pitcher region of interest 404 and the batter regions of interest 408A, 408B, a computing system may identify the pitcher and the batter as the persons standing within the corresponding regions of interest. In some embodiments, because the players' feet are expected to be in contact with the ground for much of the time, a middle-bottom coordinate of each bounding box is used to indicate the player's position on the field. That middle-bottom coordinate may be used because the middle-bottom coordinate corresponds to the same coordinate plane as the pitcher region of interest 404 and the batter regions of interest 408A, 408B, which may be defined on the ground plane. If more than one person is present within a given region of interest, the person closest to the center of that region of interest may be identified as the pitcher or the batter, as applicable.

After the detected pitcher 406 and the detected batter 410 are identified, one or more triggering conditions may be evaluated to capture a gameplay scenario that indicates that a pitch has occurred or is occurring. In some implementations, a short history of location coordinates associated with the detected pitcher 406 may also be stored and used in evaluating the triggering conditions.

A first triggering condition may correspond to a determination that the detected pitcher 406 was stationary and then transitioned to moving. This condition may capture a moment when the pitcher has stepped onto the pitcher's mound and is set in a stationary state, followed by a subsequent start of pitching motion.

In some implementations, displacement of the detected pitcher 406 may be computed using a history of pitcher location coordinates, and stationary and moving states may be distinguished using a threshold θm that defines a magnitude of displacement constituting player movement. For example, displacement values less than or equal to the threshold θm may be treated as stationary, and displacement values greater than the threshold θm may be treated as moving. This distinction may be useful because, even with an accurate person-detection model, predicted positions can vary slightly across consecutive frames by a few pixels even when a player is standing still, thereby causing drift in the player's location coordinate. The threshold θm may provide tolerance for such variation and may reduce false positives by preventing each small positional change from being interpreted as movement. In some examples, the first triggering condition is fulfilled when the detected pitcher 406 transitions from stationary to moving.

A second triggering condition may correspond to a determination that the detected pitcher 406 is moving toward home plate. This condition may capture a moment when the pitcher has started the pitch and is stepping toward home plate. In some implementations, a direction of movement of the detected pitcher 406 may be computed using the history of pitcher location coordinates, and the second triggering condition may be fulfilled when the detected pitcher 406 is moving toward home plate, such as downward in a backstop camera view.

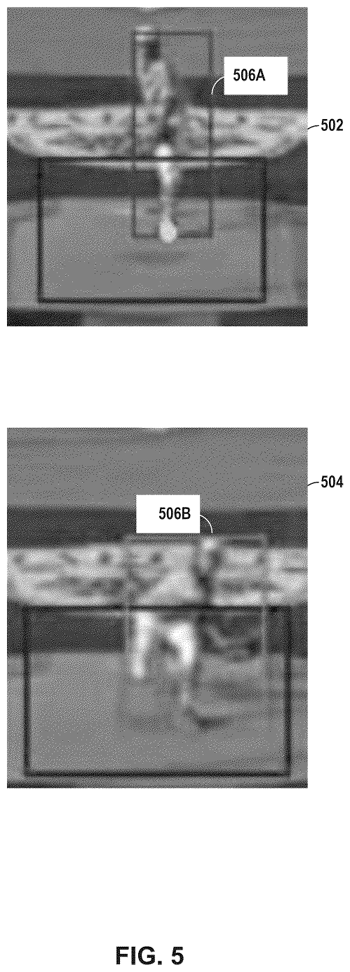

FIG. 5 is a diagram illustrating example aspect ratios of a pitcher 506A, 506B during a pitching motion, including a pre-motion image 502 and a mid-motion image 504, in accordance with one or more techniques described herein.

Condition 3: Pitcher is in the middle of a pitching motion. This condition is designed to capture the moment when the pitcher 506B starts the pitch and the ball is split seconds away from leaving the pitcher's hand. There is a change in the pitcher's bounding box pattern observed during pitches, as shown in FIG. 5, where the bounding box associated with the pitcher 506A in the pre-motion image 502 changes from a narrow vertical pattern when the pitcher is in the set, to a more square-like pattern for the pitcher 506B in the mid-motion image 504 in the middle of the pitch.

In some implementations, this is quantified by computing the aspect ratio (AR) of the pitcher's bounding box, where AR =w/h, and where w and h are the width and height of the bounding box, respectively. When the pitcher is in the set, such as in the pre-motion image 502 for pitcher 506A, the AR value may be relatively small, and during the pitch, such as in the mid-motion image 504 for pitcher 506B, the AR value may increase as the bounding box becomes more square-like. This condition may be fulfilled when the AR value of the pitcher 506B exceeds a threshold θAR, indicating that the pitcher is in the middle of a pitch.

Condition 4: Batter presence (situational). During a real, non-practice pitch in a game, a batter is typically also present. This condition adds another layer of check to the backstop-to-outfield camera switching, which may reduce potential false-positive switching. In some implementations, this condition may be fulfilled based on whether a batter was identified in the previous stage while evaluating the pitch sequence represented by the pre-motion image 502 and the mid-motion image 504.

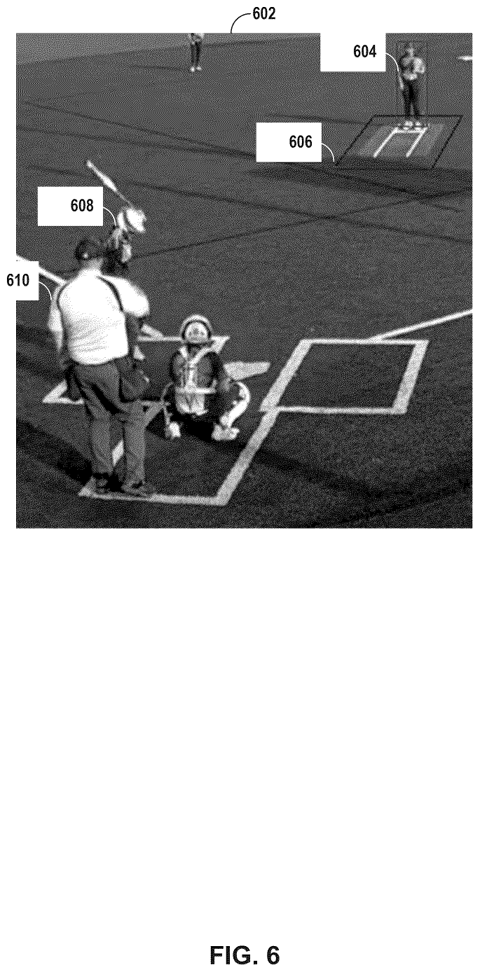

In some occasions, the backstop camera installed might not be centered, causing potential occlusion of the batter during the game. Under this scenario, Condition 4 can be disabled to suppress this condition entirely. FIG. 6 is a diagram illustrating an example offset image 602 in which a detected pitcher 604 is identified within a pitcher region of interest 606, while a detected batter 608 is at least partially occluded by an umpire 610, in accordance with one or more techniques described herein.

After switching to the outfield view, the computing device may change the switching logic to determine the timing for switching the broadcast from the outfield camera to the backstop camera. Since the backstop camera has a wider and farther view of the field, the backstop view may be a preferred view for broadcasting scenes not involving the pitching process, such as when the batter is running to first base, during stolen-base attempts, and during pickoff plays. Similar to the backstop-to-outfield switching logic, the switching timing may be dictated by triggering conditions, and for this outfield-to-backstop switching, there may be two different methods: motion-based switching and duration-based switching.

In motion-based switching, the switching condition may be designed to capture a single goal, which is to switch to the backstop camera when large and fast movement is detected among any of the players. In many scenes, such as a batter running to first base, stolen-base attempts, and pickoff plays, one common underlying pattern is that one or more players may be running quickly and/or over a substantial distance toward a base. As a result, detection of such movement may positively indicate that the computing system is to switch to the backstop camera to broadcast the play. Although this goal is straightforward, there may be several components in the switching decision pipeline, including detection, tracking, and perspective transform.

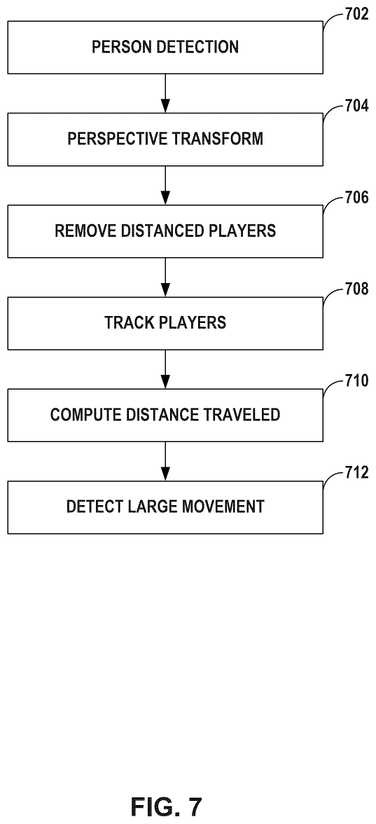

FIG. 7 is a flow diagram illustrating an example motion-based process for switching camera feeds, in accordance with one or more techniques described herein. Person detection is performed using pre-trained person detection models to obtain players'bounding boxes in the frame. As shown in FIG. 7, FIG. 7 illustrates an example motion-based process for switching camera feeds. In the example of FIG. 7, the process includes person detection 702, perspective transform 704, remove distanced players 706, track players 708, compute distance traveled 710, and detect large movement 712. In accordance with the techniques described herein, the process of FIG. 7 may be used after switching to an outfield view to detect a catalyst event corresponding to a rapid and substantial movement of one or more players and, based on the detected catalyst event, determine whether to switch the broadcast from the outfield view back to a backstop view. One or more steps of FIG. 7 may be performed by components of FIG. 2, such as analysis module 222 and communication module 220. FIG. 7 thus illustrates a specific example of a motion-based switching pipeline.

Person detection 702 may include analyzing one or more video streams using a person detection model to identify and localize persons within video frames. In some examples, person detection 702 outputs bounding boxes corresponding to one or more players visible in a frame. The bounding boxes may provide input to perspective transform 704, which may perform a top-down perspective transform on each of the bounding boxes to compute positions of the one or more players on a common field coordinate system. By computing positions on the common field coordinate system, perspective transform 704 may normalize player locations represented in an angled camera view and allow more reliable comparison of movement among players located at different apparent depths in the image.

Remove distanced players 706 may exclude from analysis any detected persons whose computed positions are located at a Euclidean distance exceeding a predetermined radius from a reference point corresponding to home plate. In some examples, remove distanced players 706 filters out players that appear relatively small or are detected inconsistently because of distance from the camera, thereby reducing propagation of detection error into later stages of the process. The remaining players may then be processed by track players 708, which may assign and maintain an identifier for each player across consecutive frames so that a position history can be associated with the respective player over time.

Compute distance traveled 710 may calculate a Euclidean distance traveled by each of the one or more players over a predetermined time interval based on the position history associated with the respective player. Detect large movement 712 may then determine whether the calculated travel of any player indicates a rapid and substantial movement of one or more players. When such rapid and substantial movement is detected, the computing device may determine that a catalyst event has occurred and may switch the broadcast from a first camera view to a second camera view. In this way, the process of FIG. 7 may support responsive camera switching during gameplay situations such as base running, stolen base attempts, or pickoff attempts while reducing false positive switching caused by distant or inconsistently detected players.

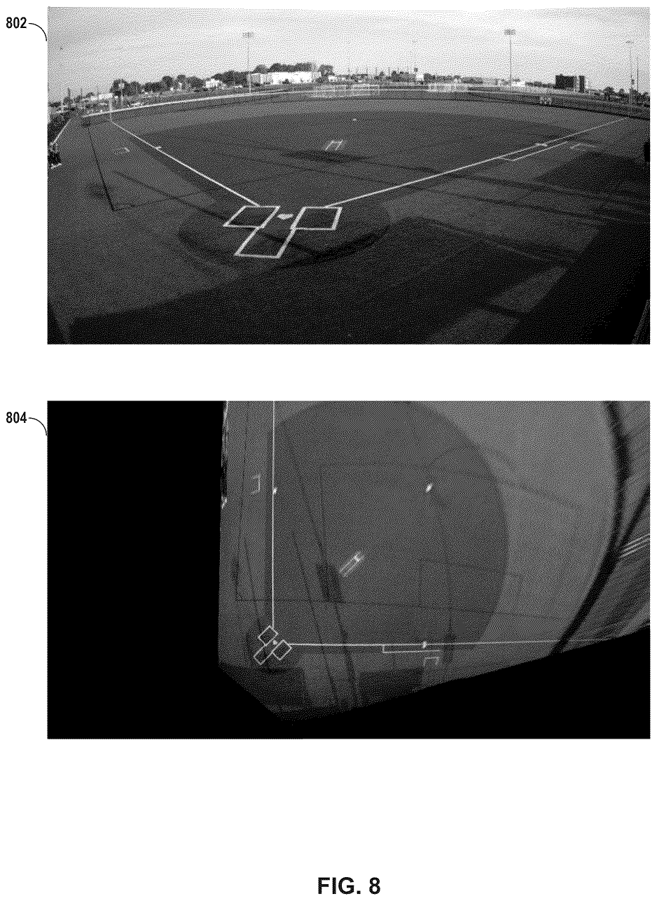

FIG. 8 is a diagram illustrating images before and after a perspective transform, including a pre-perspective transform image 802 and a top-down perspective transform image 804, in accordance with one or more techniques described herein. After detecting persons on the field, the next step may be to perform a top-down perspective transform using the bounding boxes to obtain a more accurate depiction of player positions on the field. For example, in the pre-perspective transform image 802, a player standing closer to the camera and moving 200 pixels to the left might correspond to movement of about 20 feet on the field, whereas a player farther from the camera and moving the same 200 pixels to the left might correspond to movement of about 200 feet on the field. The perspective transform from the pre-perspective transform image 802 to the top-down perspective transform image 804 may scale and project player positions onto the field to enable fair comparison and numerical representation of player position and distance traveled.

Given the player positions on the field in the top-down perspective transform image 804, the next step may be to remove players that are very far away from the camera. In some implementations, this may be performed by computing a Euclidean distance between each player's position in the top-down perspective transform image 804 and home plate, and treating players standing more than a radius R from home plate as far or distanced players to be removed from subsequent analysis. Such removal may reduce propagation of error into later stages of the pipeline. For example, players at the far end of the field may appear relatively small in the pre-perspective transform image 802, which may occasionally cause inconsistent person detection, such that a given player is detected in some frames but not in others. This inconsistent on-and-off detection may create difficulty in the tracking stage and may trigger false-positive switching if not addressed earlier in the pipeline.

Player tracking may be performed using a tracking algorithm such as a Simple Online and Realtime Tracking (SORT) algorithm, in which each bounding box is assigned an identifier and players retain the same identifier across consecutive frames when determined to correspond to the same person. In other examples, other tracking algorithms may be used, and any suitable player-tracking algorithm may be employed with these techniques. If a player is not detected in one or more consecutive frames, such as because the player is far from the camera in the pre-perspective transform image 802, one of at least two scenarios may occur. In a first scenario, the player may be assigned a new tracking identifier, such that the player is interpreted as a new player on the field and a disconnect is created between position histories associated with the old and new identifiers. In a second scenario, the player may retain the correct identifier, but because the player was not detected in some frames, the numerical position history may make the player appear to have traveled a large distance in a short time. Either scenario may create issues in subsequent switching analysis.

A further step may include computing the distance traveled by each player and detecting any large movement that would trigger a switch of camera view. By scanning the history associated with each player identifier, the computing device may retrieve each player's position during the last T seconds and compute the distance traveled, such as using a Euclidean distance calculation based on the transformed positions in the top-down perspective transform image 804. However, in the first scenario described above, the travel distance for a player may be significantly shortened because the player's travel history was split between two identifiers. In the second scenario, if the player is detected in one location, not detected in several consecutive frames, and then detected again in a different location, the history of that identifier may create the appearance that the player traveled a large distance in a short time, which may trigger unnecessary switching.

In a duration-based method, the switching condition may be to broadcast the outfield view for a duration D and then switch back to the backstop view when the outfield broadcast duration reaches D seconds. In one example, the duration D may be set to 3 seconds, which may be sufficient to broadcast the sequence from the start of a pitch to the end of the batter's batting action. In other examples, the duration D may be any length of time suitable for the particular situation being broadcast by the multiple cameras. This method may be relatively simple and fast because it may not require additional computation to determine switch timing as compared to the motion-based method.

In some implementations, the analysis may be performed L frames ahead of the broadcast, which allows the analysis to look ahead and make a switching decision before the broadcast reaches the corresponding frame. When a switching decision is made during the analysis because one or more trigger conditions are fulfilled, the switching decision may be paired with an earlier timestamp instead of the timestamp of the current analysis frame. This may be useful because the switching decision may be triggered when an event is already occurring, such as in the middle of a pitch or while a player is already sprinting. To broadcast the beginning of the event, the switch may be applied earlier so that viewers can observe the entire event. For example, in backstop-to-outfield switching, the conditions may be triggered in the middle of a pitch. To broadcast the full pitching process, the switching decision may therefore be placed d seconds earlier so that the outfield broadcast shows the complete pitch from start to end rather than switching in the middle of the pitch.

In some examples, for outfield-to-backstop switching, the earlier placement of the switching decision may satisfy:

d_{O2B}≤L
where d_{O2B} denotes an amount of earlier placement for an outfield-to-backstop switching decision and L denotes the size of a first-in, first-out buffer.

In some examples, for backstop-to-outfield switching, the earlier placement of the switching decision may satisfy:

d_{B2O}≤L

where d_{B2O} denotes an amount of earlier placement for a backstop-to-outfield switching decision and Ldenotes the size of the first-in, first-out buffer.

Where d determines how much earlier the switching decision is placed, and L is the FIFO buffer size (also, the amount of delay between live analysis and broadcast).

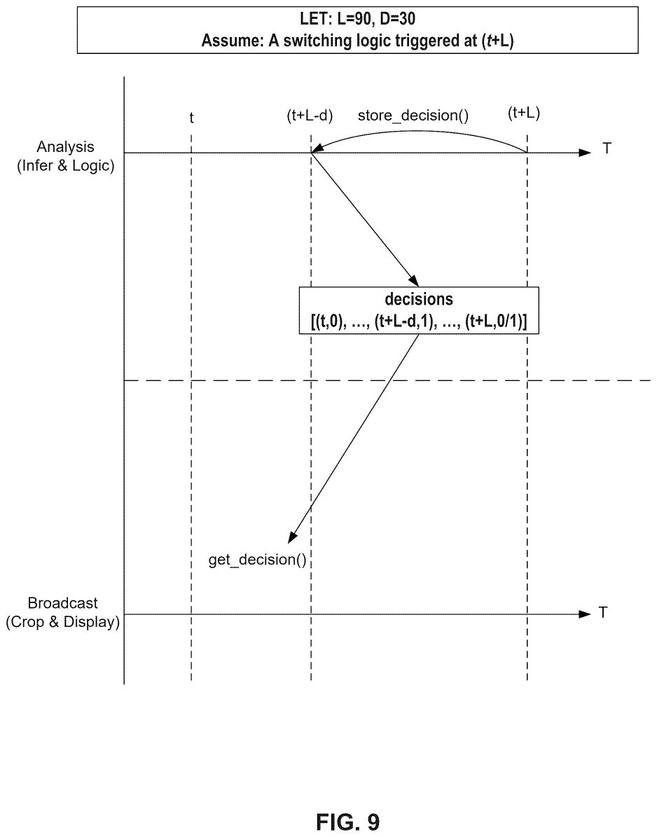

FIG. 9 is a conceptual diagram illustrating an example analysis and broadcast operating timeline, in accordance with one or more techniques described herein. Any one or combination of programming languages capable of providing code for the analysis logic and the broadcast logic may be used, including traditional programming languages, such as C++, and scripting languages, such as Python.

FIG. 9 is a conceptual diagram illustrating an example analysis and broadcast operating timeline, in accordance with one or more techniques described herein. As shown in FIG. 9, the operating timeline may include an Analysis (Infer & Logic) portion and a Broadcast (Crop & Display) portion arranged along a time axis T. In the example of FIG. 9, the analysis is L frames ahead of the broadcast, such that an analyze frame at time t+Lis evaluated before a corresponding display frame is broadcast. The example further shows a switching logic triggered at t+L, where ddetermines how much earlier a switching decision is placed and Lcorresponds to a first-in-first-out buffer size representing a delay between live analysis and broadcast.

In accordance with the techniques described herein, the Analysis (Infer & Logic) portion may infer a switching outcome based on one or more trigger conditions and may execute store_decision() to associate the switching outcome with an earlier timestamp. In the illustrated example, although the switching logic is triggered at t+L, the switching decision is placed at t+L-drather than at the current analysis time. This earlier placement may allow a broadcast stream to present a start of an event instead of switching after the event is already underway. In some examples, the value of d may be selected such that the earlier placement remains within the delay provided by the first-in-first-out buffer.

FIG. 9 further illustrates a decisions data structure that may store timestamped decisions, such as decisions [(t ,0), . . . , (t+L−d,1), . . . , (t+L,0/1)]. The decisions data structure may be implemented as a queue or another data structure suitable for storing switching decisions generated by the analysis. As further shown, the Broadcast (Crop & Display) portion may execute get_decision() to retrieve a decision corresponding to a broadcast time and may combine that decision with timestamped video frames retrieved from the first-in-first-out buffer to determine which camera view is broadcast. In this way, the operating timeline of FIG. 9 illustrates how analysis performed ahead of broadcast may support anticipatory camera switching and more accurate presentation of an event from its beginning.

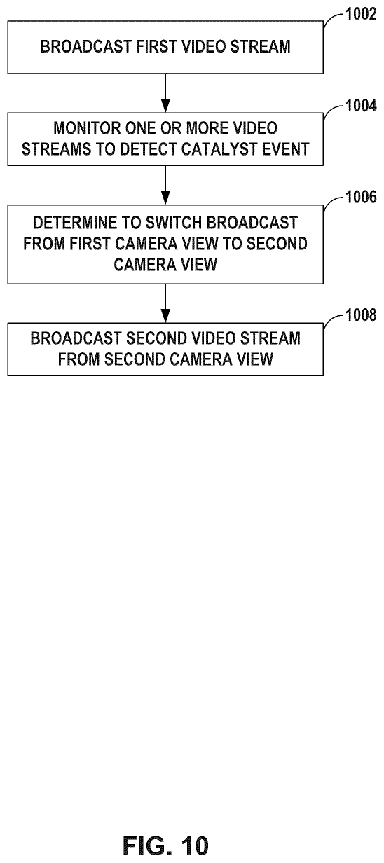

FIG. 10 is a flow chart illustrating an example mode of operation. The techniques of FIG. 10 may be performed by one or more processors of a computing device, such as system 100 of FIG. 1 and/or computing device 210 illustrated in FIG. 2. For purposes of illustration only, the techniques of FIG. 10 are described within the context of computing device 210 of FIG. 2, although computing devices having configurations different than that of computing device 210 may perform the techniques of FIG. 10.

In accordance with the techniques of this disclosure, communication module 220 broadcasts a first video stream from a first camera view from a plurality of camera views (1002). Analysis module 222 monitors one or more video streams from the plurality of camera views to detect a catalyst event (1004). Analysis module 222 determines, based on the detected catalyst event, to switch the broadcast from the first camera view to a second camera view of the plurality of camera views (1006). In response to determining to switch the broadcast, communication module 220 switches to broadcasting a second video stream from the second camera view instead of the first video stream from the first camera view (1008).

In one example implementation, the disclosed system may be deployed at a baseball or softball field having a first camera mounted on or near a backstop and directed toward the outfield and a second camera mounted in the outfield and directed toward home plate. During a live game, both cameras may continuously capture video streams and transmit the video streams to a computing device configured to perform automated camera selection. The computing device may include one or more processors, a communication module, an analysis module, and a data store that stores recent frames from the respective video streams in a first-in-first-out buffer. At the beginning of the game, the computing device may default the broadcast to the backstop-facing-outfield view, which may provide broader coverage of field activity before and after a pitch.

During operation, the analysis module may analyze one or more frames from at least one of the video streams to detect a catalyst event indicating that a switch in broadcast view is appropriate. For example, while the backstop view is being broadcast, the analysis module may analyze the backstop camera frames to identify a pitcher and a batter using a person detection model and predefined regions of interest associated with the field. The analysis module may determine that a pitch sequence is occurring based on one or more conditions, such as a pitcher transitioning from stationary to moving, movement of the pitcher toward home plate, an increase in a pitcher's bounding-box aspect ratio indicating pitching motion, and optionally the presence of a batter. In response to detecting the pitch sequence, the computing device may switch the broadcast from the backstop view to the outfield-facing-home-plate view so that the pitch, ball trajectory, and batting action are shown from a more suitable angle.

After the switch to the outfield view, the computing device may continue monitoring gameplay to determine when to return the broadcast to the backstop view. In some embodiments, the analysis module may detect rapid and substantial movement of one or more players by detecting persons in the outfield-view frames, transforming player positions into a common field coordinate system, filtering out players beyond a threshold distance from home plate, tracking player movement across frames, and determining whether a player has traveled a sufficient distance over a defined time interval. Such movement may correspond to a batter running to first base, a stolen-base attempt, or a pickoff play. In response to detecting such movement, the computing device may switch the broadcast back to the backstop view, which may provide broader visual coverage of the developing field action. In some examples, the computing device may additionally or alternatively return to the backstop view after a predetermined duration if a motion-based trigger is not detected.

In some examples, the computing device may perform the analysis on frames that are temporally ahead of frames currently being output in the broadcast. By storing recent video frames in the first-in-first-out buffer and associating switching decisions with earlier timestamps, the system may apply a switching decision before the corresponding event is fully underway in the displayed stream. This may allow the broadcast to present the beginning of a pitch or the start of a base-running play rather than switching after the action has already started. In this manner, the disclosed system may be used in a real-world live sports broadcast environment to automate camera switching between multiple installed cameras while reducing manual intervention and improving the timeliness and relevance of the broadcasted view.

In one example implementation adapted for a softball field, the disclosed system may be deployed at a softball venue having a first camera mounted on or near a backstop and directed generally toward an infield and outfield, and a second camera mounted in an outfield-facing position and directed generally toward home plate and a pitcher. The first camera and the second camera may continuously capture video streams during a live softball game and provide the video streams to a computing device configured to perform automated camera selection. The computing device may include one or more processors, a memory, a communication interface, and one or more modules configured to execute detection, tracking, perspective transformation, switching logic, and broadcast output functions. In some embodiments, the computing device may maintain a first-in, first-out buffer storing recent frames from the respective video streams so that switching decisions can be applied to earlier timestamps in the broadcast stream. During operation, the computing device may initially broadcast a backstop view and may analyze frames of the backstop view to identify a pitcher and a batter using player detections and one or more regions of interest defined for the softball field. Because softball fields may differ from baseball fields in pitcher distance, basepath geometry, and camera placement, the regions of interest, movement thresholds, duration thresholds, and perspective transform parameters may be calibrated for the particular softball venue. The computing device may determine that a pitch sequence is occurring based on one or more trigger conditions including a pitcher transitioning from stationary to moving, a pitcher moving toward home plate, a change in a bounding-box aspect ratio associated with a pitching motion, and, in some embodiments, a detected batter. In response to detecting the pitch sequence, the computing device may switch a live stream from the backstop view to the outfield view so that a pitch and a batting action are presented from a more suitable angle. After switching to the outfield view, the computing device may monitor for rapid and substantial player movement corresponding to events such as a batter running to first base, an attempted steal, or a play at a base, and may switch back to the backstop view when the movement satisfies one or more movement-based conditions or when a duration-based condition is satisfied. In this manner, the disclosed system may be implemented in a real-life softball broadcast environment to automate camera selection while accommodating characteristics of softball gameplay and field layout.

In another example implementation, the disclosed system may be implemented in a cloud-based remote broadcast workflow in which video streams from a backstop camera and an outfield camera are transmitted over one or more networks from a sports venue to a remote computing environment. In some embodiments, the remote computing environment may include one or more cloud servers configured to receive the video streams, store recent frames in one or more buffers, execute person detection and tracking models, perform perspective transforms, evaluate trigger conditions, and generate switching decisions for a live program output. A venue-side device may encode and transmit the video streams, while the cloud servers may perform the switching analysis and may output a selected program feed to a remote production system, a streaming platform, or both. During operation, the cloud servers may analyze frames that are temporally ahead of frames currently being broadcast so that a switching decision triggered by a detected pitch sequence or a detected catalyst event can be associated with an earlier timestamp. The earlier timestamp may allow the remote workflow to present the beginning of a pitch, a batting action, or a base-running play in the output stream rather than switching after the action is already underway. In some embodiments, the remote computing environment may receive calibration information for a particular venue, including one or more regions of interest, field landmarks, home plate coordinates, and perspective transform parameters, and may apply the calibration information to normalize player positions and evaluate movement across frames. The cloud-based workflow may further enable a single remote system to support multiple venues by loading venue-specific configuration data for a selected event and applying automated switching logic to the corresponding video streams. In this manner, the disclosed system may be implemented in a real-life remote production architecture that reduces on-site production demands while providing automated camera switching for live sports broadcasts.

Example 1. A method for automated camera switching in a broadcast system, comprising: broadcasting, by one or more processors, a first video stream from a first camera view from a plurality of camera views; monitoring, by the one or more processors, one or more video streams from the plurality of camera views to detect a catalyst event; determining, by the one or more processors, and based on the detected catalyst event, to switch the broadcast from the first camera view to a second camera view of the plurality of camera views; and in response to determining to switch the broadcast, switching, by the one or more processors, to broadcasting a second video stream from the second camera view instead of the first video stream from the first camera view.

Example 2. The method of Example 1, wherein detecting the catalyst event comprises: detecting, by the one or more processors, a pitcher, identified within a predefined region of interest, transitioning from a stationary state to a moving state based on a predetermined displacement threshold.

Example 3. The method of any one or more of Examples 1-2, wherein detecting the catalyst event comprises: determining, by the one or more processors, a coordinate history of a pitcher, identified within a predefined region of interest, is indicative of motion towards home plate.

Example 4. The method of any one or more of Examples 1-3, wherein detecting the catalyst event further comprises: determining, by the one or more processors, that a pitcher is performing a pitching motion by detecting that an increase in an aspect ratio of a bounding box of the pitcher exceeds a predetermined threshold.

Example 5. The method of any one or more of Examples 1-4, wherein detecting the catalyst event further comprises: identifying, by the one or more processors, a pitching motion while a batter is simultaneously present in the first camera view.

Example 6. The method of any one or more of Examples 1-5, further comprising: storing, by the one or more processors, video frames from each of the plurality of camera views in a first-in-first-out (FIFO) buffer, wherein detecting the catalyst event comprises performing, by the one or more processors, analysis on an analyze frame that is a particular distance from a corresponding display frame in the broadcasted first camera view to facilitate anticipatory switching.

Example 7. The method of Example 6, wherein switching the broadcast from the first camera view to the second camera view comprises: switching, by the one or more processors, the broadcast at a particular frame timestamp that is prior to a timestamp of the analysis frame.

Example 8. The method of any one or more of Examples 1-7, wherein monitoring the one or more video streams comprises: analyzing, by the one or more processors, the video streams using a person detection model based to identify and localize persons within the video frames.

Example 9. The method of Example 8, wherein the identified persons are correlated with predefined regions of interest corresponding to a pitcher and a batter.

Example 10. The method of any one or more of Examples 1-9, wherein detecting the catalyst event comprises: detecting, by the one or more processors, a rapid and substantial movement of one or more players by calculating a Euclidean distance traveled by each of the one or more players over a predetermined time interval.

Example 11. The method of Example 10, wherein detecting the rapid and substantial movement further comprises: using, by the one or more processors, a person detection model based to identify the one or more players and localize the one or more players using bounding boxes; performing, by the one or more processors, a top-down perspective transform on each of the bounding boxes to compute positions of the one or more players on a common field coordinate system; excluding, by the one or more processors, from analysis any detected persons whose computed positions are located at a Euclidean distance exceeding a predetermined radius from a reference point corresponding to home plate; and detecting, by the one or more processors, the rapid and substantial movement of the one or more players by calculating the Euclidean distance traveled by each of the one or more players over the predetermined time interval.

Example 12. The method of any one or more of Examples 1-11, further comprising: automatically reverting, by the one or more processors, the broadcast from the second camera view back to the first camera view after a predetermined duration.

Example 13. The method of any one or more of Examples 1-12, wherein detecting the catalyst event comprises: detecting, by the one or more processors, a passing of a predetermined duration.

Example 14. The method of any one or more of Examples 1-13, wherein the first camera view comprises a view of a backstop from a camera located in an outfield, and wherein the second camera view comprises a view of the outfield from a camera located on the backstop.

Example 15. The method of any one or more of Examples 1-13, wherein the first camera view comprises a view of an outfield from a camera located on a backstop, and wherein the second camera view comprises a view of the backstop from a camera located in the outfield.

Example 16. The method of any one or more of Examples 1-15, wherein monitoring the one or more video streams comprises: analyzing, by the one or more processors, the second video stream to detect the catalyst event in the second video stream while broadcasting the first video stream.

Example 17. The method of any one or more of Examples 1-15, wherein monitoring the one or more video streams comprises: analyzing, by the one or more processors, the first video stream to detect the catalyst event in the first video stream while broadcasting the first video stream.

Example 18. A method for performing any of the techniques of any combination of Examples 1-17.

Example 19. A device configured to perform any of the methods of any combination of Examples 1-17.

Example 20. An apparatus comprising means for performing any of the method of any combination of Examples 1-17.

Example 21. A non-transitory computer-readable storage medium having stored thereon instructions that, when executed, cause one or more processors of a computing device to perform the method of any combination of Examples 1-17.

Example 22. A system comprising one or more computing devices configured to perform a method of any combination of Examples 1-17.

Example 23. Any of the techniques described herein.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method for automated camera switching in a broadcast system, comprising:
broadcasting, by one or more processors, a first video stream from a first camera view from a plurality of camera views;
monitoring, by the one or more processors, one or more video streams from the plurality of camera views to detect a catalyst event;
determining, by the one or more processors, and based on the detected catalyst event, to switch the broadcast from the first camera view to a second camera view of the plurality of camera views; and
in response to determining to switch the broadcast, switching, by the one or more processors, to broadcasting a second video stream from the second camera view instead of the first video stream from the first camera view.

2. The method of claim 1, wherein detecting the catalyst event comprises:
detecting, by the one or more processors, a pitcher, identified within a predefined region of interest, transitioning from a stationary state to a moving state based on a predetermined displacement threshold.

3. The method of claim 1, wherein detecting the catalyst event comprises:
determining, by the one or more processors, a coordinate history of a pitcher, identified within a predefined region of interest, is indicative of motion towards home plate.

4. The method of claim 1, wherein detecting the catalyst event further comprises:
determining, by the one or more processors, that a pitcher is performing a pitching motion by detecting that an increase in an aspect ratio of a bounding box of the pitcher exceeds a predetermined threshold.

5. The method of claim 1, wherein detecting the catalyst event further comprises:
identifying, by the one or more processors, a pitching motion while a batter is simultaneously present in the first camera view.

6. The method of claim 1, further comprising:
storing, by the one or more processors, video frames from each of the plurality of camera views in a first-in-first-out (FIFO) buffer,
wherein detecting the catalyst event comprises performing, by the one or more processors, analysis on an analyze frame that is a particular distance from a corresponding display frame in the broadcasted first camera view to facilitate anticipatory switching.

7. The method of claim 6, wherein switching the broadcast from the first camera view to the second camera view comprises:
switching, by the one or more processors, the broadcast at a particular frame timestamp that is prior to a timestamp of the analysis frame.

8. The method of claim 1, wherein monitoring the one or more video streams comprises:
analyzing, by the one or more processors, the video streams using a person detection model based to identify and localize persons within the video frames.

9. The method of claim 8, wherein the identified persons are correlated with predefined regions of interest corresponding to a pitcher and a batter.

10. The method of claim 1, wherein detecting the catalyst event comprises:
detecting, by the one or more processors, a rapid and substantial movement of one or more players by calculating a Euclidean distance traveled by each of the one or more players over a predetermined time interval.

11. The method of claim 10, wherein detecting the rapid and substantial movement further comprises:
using, by the one or more processors, a person detection model based to identify the one or more players and localize the one or more players using bounding boxes;
performing, by the one or more processors, a top-down perspective transform on each of the bounding boxes to compute positions of the one or more players on a common field coordinate system;
excluding, by the one or more processors, from analysis any detected persons whose computed positions are located at a Euclidean distance exceeding a predetermined radius from a reference point corresponding to home plate; and
detecting, by the one or more processors, the rapid and substantial movement of the one or more players by calculating the Euclidean distance traveled by each of the one or more players over the predetermined time interval.

12. The method of claim 1, further comprising:
automatically reverting, by the one or more processors, the broadcast from the second camera view back to the first camera view after a predetermined duration.

13. The method of claim 1, wherein detecting the catalyst event comprises:
detecting, by the one or more processors, a passing of a predetermined duration.

14. The method of claim 1, wherein the first camera view comprises a view of a backstop from a camera located in an outfield, and wherein the second camera view comprises a view of the outfield from a camera located on the backstop.

15. The method of claim 1, wherein the first camera view comprises a view of an outfield from a camera located on a backstop, and wherein the second camera view comprises a view of the backstop from a camera located in the outfield.

16. The method of claim 1, wherein monitoring the one or more video streams comprises:
analyzing, by the one or more processors, the second video stream to detect the catalyst event in the second video stream while broadcasting the first video stream.

17. The method of claim 1, wherein monitoring the one or more video streams comprises:
analyzing, by the one or more processors, the first video stream to detect the catalyst event in the first video stream while broadcasting the first video stream.

18. A computing device comprising one or more processors configured to:
broadcast a first video stream from a first camera view from a plurality of camera views;
monitor one or more video streams from the plurality of camera views to detect a catalyst event;
determine, based on the detected catalyst event, to switch the broadcast from the first camera view to a second camera view of the plurality of camera views; and
in response to determining to switch the broadcast, switch to broadcasting a second video stream from the second camera view instead of the first video stream from the first camera view.

19. The computing device of claim 18, wherein the one or more processors being configured to detect the catalyst event comprise the one or more processors being configured to:
detect a pitcher, identified within a predefined region of interest, transitioning from a stationary state to a moving state based on a predetermined displacement threshold.

20. A non-transitory computer-readable storage medium having stored thereon instructions that, when executed, cause one or more processors of a computing device to:
broadcast a first video stream from a first camera view from a plurality of camera views;
monitor one or more video streams from the plurality of camera views to detect a catalyst event;
determine, based on the detected catalyst event, to switch the broadcast from the first camera view to a second camera view of the plurality of camera views; and
in response to determining to switch the broadcast, switch to broadcasting a second video stream from the second camera view instead of the first video stream from the first camera view.
